(19) United States
(12) Patent Application Publication
(10) Pub. No.: US 2026/0212166 A1
(43) Pub. Date: Jul. 23, 2026

(54) INFORMATION PROCESSING DEVICE, INFORMATION PROCESSING METHOD, AND PROGRAM

(71) Applicant: NEC Corporation, Tokyo (JP)

(72) Inventors: Taiga IYOKU, Tokyo (JP); Ryosuke SHIRAI, Tokyo (JP); Masahiko TAKAHASHI, Tokyo (JP); Junya KAWAI, Tokyo (JP); Kosei KOBAYASHI, Tokyo (JP)

(73) Assignee: NEC Corporation, Tokyo (JP)

(21) Appl. No.: 19/442,120

(22) Filed: Jan. 7, 2026

(30) Foreign Application Priority Data
Jan. 22, 2025 (JP) 2025-009188

(51) Int. Cl. G06N 3/0475; G06F 40/289

(52) U.S. Cl. CPC G06N 3/0475; G06F 40/289

(57) ABSTRACT

To obtain an appropriate answer in consideration of the situation of the user in the real world, in an information processing device, a processor acquires input information input from a user, and holds real world information related to the user in a past fixed period starting from an input time point of the input information. The processor generates instruction information based on the input information and the real world information, and generates answer information based on the instruction information. This technology enables user-oriented artificial intelligence driven decision making by dynamically generating instruction information from real-world contextual data.

### INCORPORATION BY REFERENCE

This application is based upon and claims the benefit of priority from Japanese Patent Application 2025-009188, filed on January 22, 2025, the disclosure of which is incorporated herein in its entirety by reference.

### TECHNICAL FIELD

The present disclosure relates to a technology of generating an answer using generative AI.

### BACKGROUND ART

A system that generates an answer based on an instruction sentence input by a user using generative artificial intelligence (AI) has been utilized. Japanese Patent No. 7441366 discloses an information processing device that makes it possible to answer with increased accuracy to a question using a language model that is a type of the generative AI.

Patent Document 1: Japanese Patent Application Laid-Open under No. 7441366

### SUMMARY

Conventionally, in a case where an answer is generated by generative AI based on the latest instruction sentence by a user, a past instruction sentence by the user has been treated as a background and a history (hereinafter, also referred to as “context information”) leading to the instruction, and the answer has been generated in consideration of the context information. However, since the context that can be grasped from the past instruction sentence is limited, there has been a problem that it is not possible to answer based on a situation of the user who has issued the instruction in the real world, and an answer required by the user cannot be obtained from the generative AI.

An object of the present disclosure is to obtain an appropriate answer in consideration of the situation of the user in the real world.

According to an example aspect of the present invention, there is provided an information processing device including:

at least one memory configured to store instructions; and

at least one processor configured to execute the instructions to:

acquire input information input from a user;

hold real world information related to the user in a past fixed period starting from an input time point of the input information;

generate instruction information based on the input information and the real world information; and

generate answer information based on the instruction information.

According to another example aspect of the present invention, there is provided an information processing method executed by an information processing device, the method including:

acquiring input information input from a user;

holding real world information related to the user in a past fixed period starting from an input time point of the input information;

generating instruction information based on the input information and the real world information; and

generating answer information based on the instruction information.

According to still another example aspect of the present invention, there is provided a non-transitory computer-readable recording medium storing a program causing a computer to execute processing of:

acquiring input information input from a user;

holding real world information related to the user in a past fixed period starting from an input time point of the input information;

generating instruction information based on the input information and the real world information; and

generating answer information based on the instruction information.

### EFFECT

According to the present disclosure, it is possible to acquire an appropriate answer in consideration of a situation of a user in the real world.

### BRIEF DESCRIPTION OF THE DRAWINGS

FIG. 1 illustrates an example of a schematic configuration of an information processing system according to the present disclosure;

FIG. 2 is a diagram schematically illustrating processing by a server;

FIGS. 3A and 3B are block diagrams illustrating an example of a hardware configuration of a server and a user terminal;

FIG. 4 illustrates an example of real world information and an acquisition method;

FIG. 5 is a block diagram illustrating an example of a functional configuration of the server;

FIG. 6 is a diagram for explaining a data group;

FIG. 7 is a flowchart of answer generation processing;

FIG. 8 is a block diagram illustrating a functional configuration of an information processing device; and

FIG. 9 is a flowchart by the information processing device.

### EXAMPLE EMBODIMENTS

Hereinafter, example embodiments of the present disclosure will be described with reference to the drawings.

### First Example Embodiment

### Overall Configuration

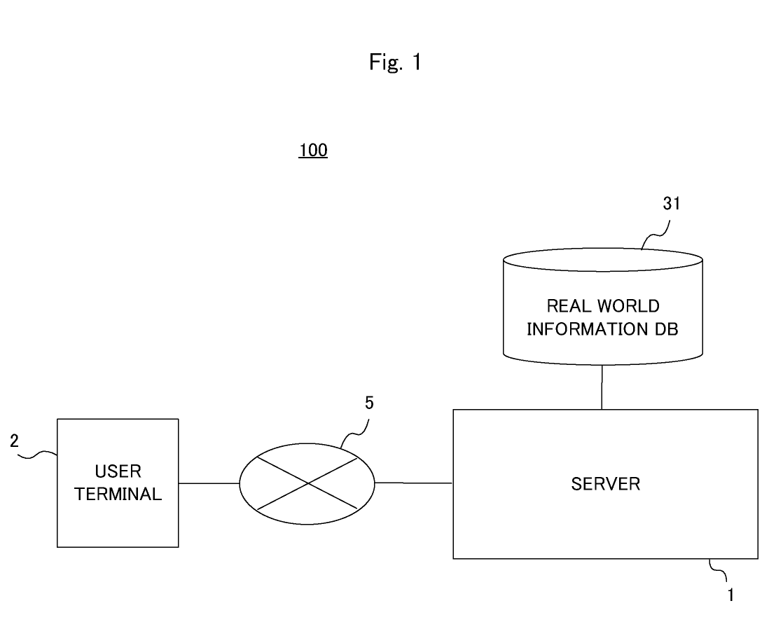

FIG. 1 is an example of a schematic configuration of an information processing system 100 to which an information processing device of the present disclosure is applied. The information processing system 100 is a system that, in a case of generating an answer using generative AI based on an instruction sentence (hereinafter, also referred to as a “prompt sentence”) input by a user, generates the answer to the instruction sentence in consideration of real world information regarding the user in a past fixed period.

In the information processing system 100 of FIG. 1, a server 1 and a user terminal 2 are communicably connected via a network 5 such as the Internet. The server 1 is an information processing device that processes, stores, and transmits/receives various data, and is connected to a real world information database (hereinafter, a “database” is referred to as a “DB”) 31.

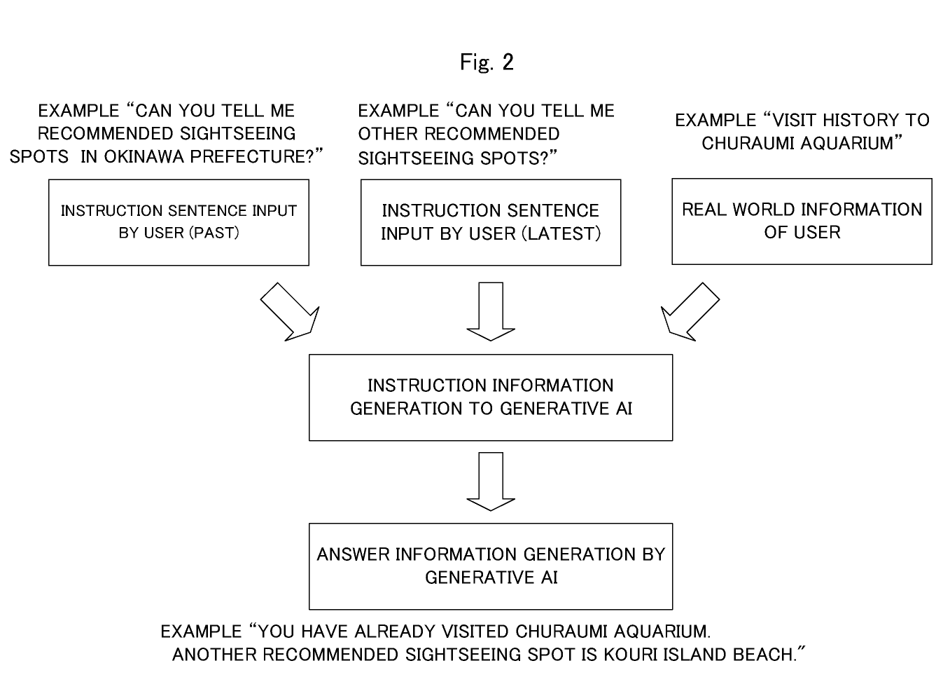

FIG. 2 is a diagram schematically illustrating processing by the server 1. As illustrated in FIG. 2, the server 1 generates instruction information to the generative AI based on a past instruction sentence “Can you tell me recommended sightseeing spots in Okinawa Prefecture?” input by the user, the latest instruction sentence “Can you tell me other recommended sightseeing spots?” input by the user, and real world information of the user “visit history to Churaumi Aquarium”. By inputting the generated instruction information, the generative AI generates answer information “You have already visited Churaumi Aquarium. Another recommended sightseeing spot is Kouri Island Beach”.

The server 1 receives the instruction sentence input by the user from the user terminal 2, and transmits the answer information regarding the answer generated using the generative AI to the user terminal 2. The server 1 may be a virtual server present in a cloud environment. The server 1 is an example of the information processing device of the present disclosure.

The user terminal 2 is a smartphone, a smart watch, and the like used by the user, and transmits, to the server 1, the instruction sentence input by the user and the real world information acquired from the sensor, and receives the answer information from the server 1. The user terminal 2 is an example of a terminal used by a target of the present disclosure.

### Hardware Configuration

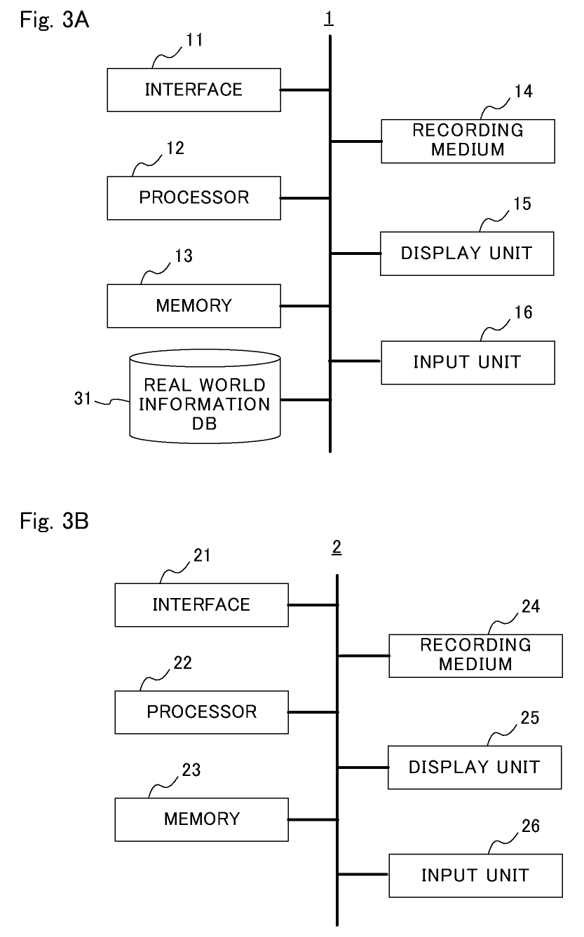

FIG. 3A is a block diagram illustrating an example of a hardware configuration of the server 1. As illustrated in FIG. 3A, the server 1 includes an interface 11, a processor 12, a memory 13, a recording medium 14, a display unit 15, and an input unit 16. These components and a real world information DB 31 are connected via a bus.

The interface 11 exchanges data with the user terminal 2. The interface 11 is used to receive the instruction sentence and the real world information from the user terminal 2, and transmit the answer information to the user terminal 2.

The processor 12 is a computer such as a central processing unit (CPU), and controls the entire server 1 by executing a program prepared in advance. As the processor 12, a CPU, a Graphics Processing Unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of them, or the like can be used.

The memory 13 includes a read only memory (ROM), a random access memory (RAM), and the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In a case where the server 1 executes answer generation processing, the program recorded in the recording medium 14 is loaded into the memory 13 and executed by the processor 12.

The display unit 15 is, for instance, a liquid crystal display (LCD) and the like, and displays a predetermined image. The input unit 16 is a keyboard, a mouse, a touch panel, and the like, and is used by an operator who manages the server 1.

The real world information DB 31 stores the real world information related to the user in a past fixed period starting from an input time point of the latest instruction information by the user. The real world information is information obtained from a device and a sensor that collect an actual state of the world, and is information that can be acquired from, for instance, a smartphone, a smart watch, and the like. Examples of the real world information include time information regarding time, spatial information regarding a space, information regarding an action purpose, attribute information regarding an attribute of the user, and the like. Specifically, the attribute information is health information related to health of the user, interest information related to interest of the user, occupation information related to occupation of the user, and the like.

As is described later in detail, the server 1 defines in advance specific parameters to be the time information, the spatial information, the action purpose information, and the attribute information with respect to each acquisition method of the time information, the spatial information, the action purpose information, and the attribute information, and extracts each information from the real world information by filtering non-target data to remove information to be noise.

The server 1 includes the real world information DB 31, but is not limited thereto, and may directly acquire and hold the real world information in a past fixed period starting from the input time point of the latest instruction information by the user from the user terminal 2.

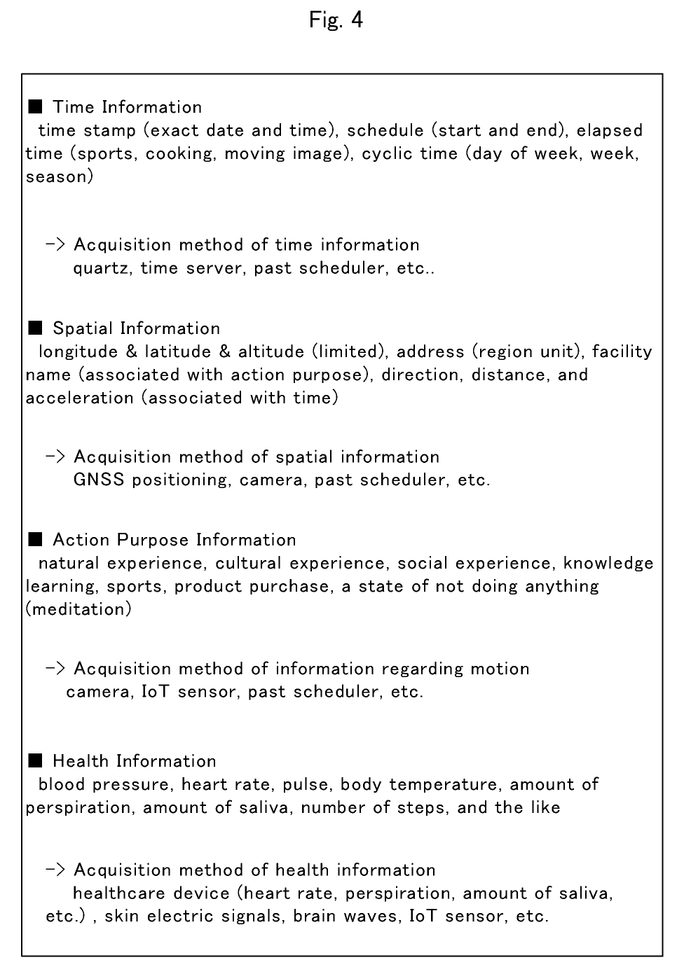

FIG. 4 illustrates an example of the real world information and the acquisition method thereof. As illustrated in FIG. 4, the time information is a time stamp, a schedule, an elapsed time, a cyclic time, and the like, and is acquired using quartz, a time server, a past scheduler, and the like via the user terminal 2. The time stamp is information indicating an accurate date and time. The schedule is information of a period indicating a start date and time and an end date and time of the schedule. The elapsed time is, for instance, information indicating a length of time from what time to what time a predetermined action is performed based on a start date and time and an end date and time of sports, cooking, movie viewing, and the like. The cyclic time is information indicating a cycle of a predetermined action cyclically performed in each day of the week, each week, and each season. The time information may be associated with the spatial information, the action purpose information, and the attribute information.

As illustrated in FIG. 4, the spatial information is latitude, longitude, and altitude, an address, a facility name, a direction and a distance, and the like, and is acquired using global navigation satellite system (GNSS) positioning, a camera, a past scheduler, and the like via the user terminal 2. The latitude, longitude, and altitude are information indicating one point in a limited manner. The address is information indicating a position in region unit, and the facility name is information indicating a facility present at a predetermined position. The direction and distance are, for instance, information indicating a range of presence in movement from a point A to a point B. The spatial information is not limited to absolute position designation indicating one point, and may be relative position designation with a certain point as a starting point, such as the direction and distance. The spatial information may be associated with the time information, the action purpose information, and the attribute information.

As illustrated in FIG. 4, the action purpose information is natural experience, cultural experience, social experience, knowledge learning, sports, product purchase, a state of not doing anything (meditation), and the like. The action purpose is estimated using various techniques of predicting the action of the user based on information of motion acquired using the camera, an Internet of Things (IoT) sensor, the past scheduler, and the like via the user terminal 2. For instance, the server 1 estimates the action purpose of the user, such as riding on a train or playing sports, based on the information of motion acquired using an acceleration sensor. The action purpose information may be associated with the time information, the spatial information, and the attribute information.

The action purpose of the user may be estimated by integrating the information acquired using, for instance, the camera, the IoT sensor, the past scheduler, and the like, and inputting the integrated information and the instruction sentence requesting estimation of the action purpose to the generative AI.

The action purpose may be estimated based on the time information, the spatial information, and the attribute information in addition to the information of motion. For instance, the server 1 estimates the action purpose of the user as “travel” in a case where “travel” is input at a predetermined date and time based on the information acquired from the scheduler. Based on the information acquired from the GNSS, the server 1 estimates the action purpose of the user as “sightseeing” in a case where the user goes to a distant point different from a usual living area and is on a holiday.

In a case where the attribute information is, for instance, the health information, as illustrated in FIG. 4, the health information is a blood pressure, a heart rate, a pulse, a body temperature, an amount of perspiration, an amount of saliva, the number of steps, and the like, and is acquired using a healthcare device, skin electric signal, brain waves, an IoT sensor, and the like via the user terminal 2. The attribute information may be associated with each of the time information, the spatial information, and the action purpose information.

FIG. 3B is a block diagram illustrating an example of a hardware configuration of the user terminal 2. As illustrated in the drawing, the user terminal 2 includes an interface 21, a processor 22, a memory 23, a recording medium 24, a display unit 25, and an input unit 26.

The interface 21 exchanges data with the server 1 via the network 5. The interface 21 is used in a case of transmitting the instruction information and the real world information to the server 1 and receiving the answer information from the server 1.

The processor 22 is a computer such as a CPU, and controls an entire user terminal by executing a program prepared in advance. As the processor 22, it is possible to use a CPU, a GPU, a DSP, an MPU, an FPU, a PPU, a TPU, a quantum processor, a microcontroller, a combination of them, or the like. For instance, in a case where the user terminal 2 is the smart watch, it is possible to acquire the heart rate, pulse, blood pressure, body temperature, and the like of the user in a case where the smart watch is worn by the user and a predetermined program is executed.

The memory 23 includes a ROM, a RAM, and the like. The memory 23 stores a program executed by the processor 22. The memory 23 is also used as a working memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 is, for instance, an LCD and the like, and displays a predetermined image. The input unit 26 is a touch panel and the like, and is used in a case where the user performs a predetermined operation.

### Functional Configuration

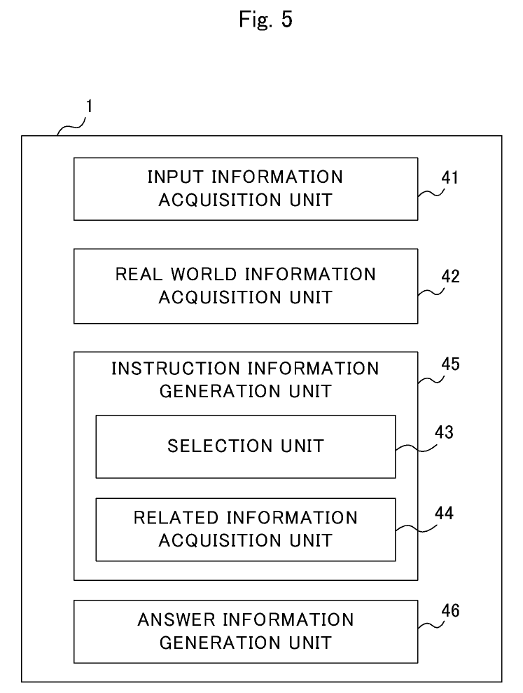

FIG. 5 is a block diagram illustrating an example of a functional configuration of the server 1. The server 1 functionally includes an input information acquisition unit 41, a real world information acquisition unit 42, a selection unit 43, a related information acquisition unit 44, an instruction information generation unit 45, and an answer information generation unit 46. The selection unit 43 and the related information acquisition unit 44 are included in the instruction information generation unit 45.

The input information acquisition unit 41, the real world information acquisition unit 42, the selection unit 43, the related information acquisition unit 44, the instruction information generation unit 45, and the answer information generation unit 46 are implemented by the processor 12 executing a program.

The input information acquisition unit 41 acquires the latest instruction sentence input by the user from the user terminal 2 as input information. For instance, as illustrated in FIG. 2, the user inputs the instruction sentence “Can you tell me other recommended sightseeing spots?” using the user terminal 2, and transmits the same to the server 1 as the input information.

The real world information acquisition unit 42 acquires the real world information related to the user in a past fixed period starting from an input time point of the latest instruction information by the user. The real world information acquisition unit 42 may analyze and acquire the real world information accumulated in the real world information DB 31 based on the input information, or may directly acquire the real world information from the user terminal 2. For instance, the real world information acquisition unit 42 acquires “visit history to Churaumi Aquarium” as the real world information from the real world information DB 31 based on the input information.

The instruction information generation unit 45 generates the instruction information to be input to the generative AI based on the input information and the real world information, and includes the selection unit 43 and the related information acquisition unit 44. The selection unit 43 selects a data group for generating the instruction information to be input to the generative AI. Specifically, the selection unit 43 extracts characteristic information related to the user from the instruction sentence and the real world information input by the user, and excludes a data group not related to the characteristic information from the selection target.

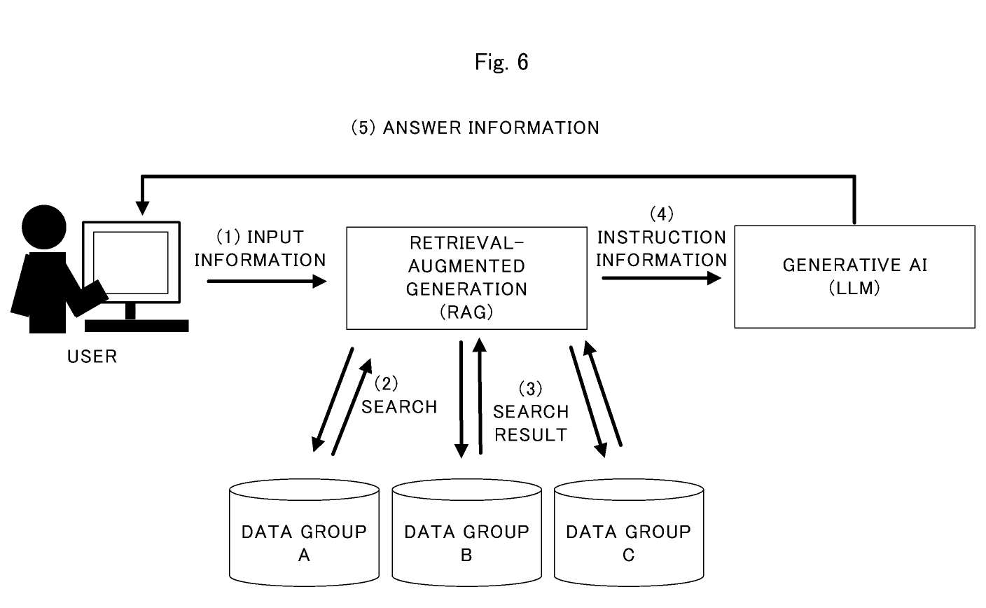

FIG. 6 is a diagram for explaining the data group. As illustrated in FIG. 6, the server 1 generates the answer information by inputting the input information and search results of data groups A to C by retrieval-augmented generation (RAG) to the generative AI as the instruction information. Here, as an example, the generative AI is a large language model (LLM) capable of understanding multi-modal information.

The RAG is a mechanism that uses external data not registered in the LLM, and the server 1 searches a data group for data similar to the latest instruction sentence by the user included in the input information, and inputs a search result together with the latest instruction sentence to the generative AI, thereby utilizing the external data. The data group may be only information personally held by the user or may include information on the web. The server 1 assigns metadata regarding information held by the data group in advance for each data group, and refers to the metadata to search for a data group that has not been excluded from the target by the selection unit 43.

For instance, the metadata may be any one of an application programming interface (API), a URL, an address of a folder, and a file name obtained from the real world information or a combination of them. Specifically, the metadata relates to the time information, the spatial information, the action purpose information, and the attribute information, and in the example illustrated in FIG. 6, “Japan” is assigned to the data group A, “America” is assigned to the data group B, and “England” is assigned to the data group C. In this case, the selection unit 43 extracts the spatial information “Churaumi Aquarium (Okinawa)” as the characteristic information from the real world information “visit history to Churaumi Aquarium”, and excludes the data group B of “America” and the data group C of “England”, which are not related to Churaumi Aquarium, from the selection target. In a case where an irrelevant data group is searched, this causes an error in the answer acquired from the generative AI. The selection unit 43 can improve the accuracy of the answer by narrowing down the data group to be referred to in consideration of the real world information. FIG. 6 is an example, and a configuration of the data group and the metadata can be optionally set. In a case of selecting the data group to be excluded from the selection target, it is possible to limit to exceed a certain evaluation value.

The related information acquisition unit 44 searches a predetermined data group based on the instruction sentence and the real world information input by the user and acquires related information related to the real world information. For instance, any one of techniques such as “vector search”, “keyword weighting search (BM25)”, “keyword perfect match search”, and “Cross-Encoder” or a combination of them may be used as a search method. In the example illustrated in FIG. 6, the related information acquisition unit 44 acquires the related information from the data group A of “Japan” based on the latest instruction sentence “Can you tell me other recommended sightseeing spots?” input by the user and the real world information “visit history to Churaumi Aquarium”. In a case where any of the action purpose information, the time information, the spatial information, and the attribute information regarding the real world information cannot be extracted from the data group, a function of periodically performing permission application for acquiring the real world information to the user may be further included.

In a case of acquiring the related information by the RAG, the instruction information generation unit 45 generates the instruction information to be input to the generative AI using the input information, the real world information, and the related information. For instance, using the latest instruction sentence “Can you tell me other recommended sightseeing spots?” included in the input information, the real world information “visit history to Churaumi Aquarium”, and the related information, the instruction information generation unit 45 excludes a place and facility where the user has already visited, and in a case where this can estimate interest/preference from the action purpose of the user, this generates the instruction information for obtaining detailed information matching the interest/preference.

The answer information generation unit 46 generates the answer information by inputting the instruction information to the generative AI. At that time, the generative AI extracts the past instruction sentence by the user stored in a cache, and generates the answer information in consideration of the past instruction sentence. Specifically, the past instruction sentence includes the instruction sentences for a predetermined number of times in the past in the same session.

The past instruction information by the user is stored in the cache of the generative AI, but is not limited thereto, and may be stored in a predetermined DB and the like. In this case, the instruction information generation unit 45 generates the instruction information to be input to the generative AI based on the input information, the real world information, and the past instruction information.

In the above configuration, the selection unit 43, the related information acquisition unit 44, the instruction information generation unit 45, and the answer information generation unit 46 of the server 1 are examples of a selection means, an acquisition means, an instruction information generation means, and an answer information generation means of the present disclosure, respectively. The real world information DB 31 of the server 1 is an example of a holding means of the present disclosure.

### Answer Generation Processing

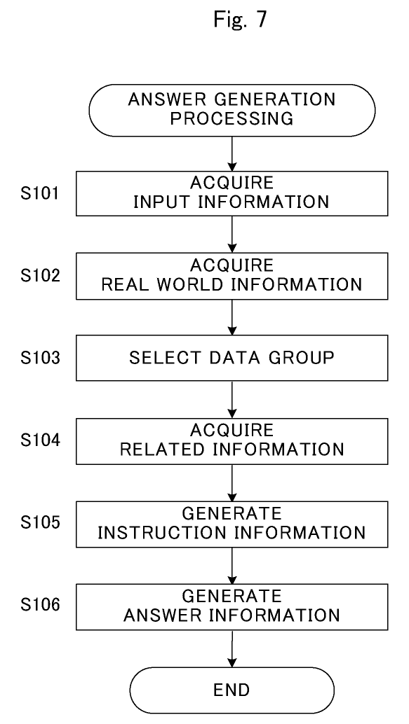

Next, answer generation processing by the server 1 will be described. FIG. 7 is a flowchart illustrating an example of the answer generation processing by the server 1. This processing is implemented by the processor 12 illustrated in FIG. 3A executing a program prepared in advance.

First, the server 1 acquires the latest instruction sentence input by the user from the user terminal 2 as the input information (step S101). For instance, the server 1 acquires the latest instruction sentence “Can you tell me a recommended marathon course that I should follow?” as the input information. Next, the server 1 acquires the real world information related to the user in a past fixed period starting from an input time point of the latest instruction information by the user (step S102). Based on the input information, the server 1 acquires, for instance, “marathon course”, “date and time of marathon”, “heart rate at time of marathon”, “pulse at time of marathon”, and the like of the user as the real world information.

Next, the server 1 selects a data group to be referred to for generating the instruction information to be input to the generative AI (step S103). The server 1 extracts the characteristic information related to the user from the input information and the real world information, and excludes a data group not related to the characteristic information from the selection target. For instance, in the data group as illustrated in FIG. 6, the server 1 extracts the spatial information “marathon course (Setagaya Ward)” from the real world information as the characteristic information, and excludes the data group B of “America” and the data group C of “England”, which are not related to the marathon course in Setagaya Ward, from the selection target.

Next, the server 1 acquires the related information related to the real world information from a predetermined data group based on the input information and the real world information (step S104). For instance, in a case of the data group as illustrated in FIG. 6, the server 1 acquires the related information from the data group A of “Japan” based on the input information and the real world information. The server 1 generates the instruction information to be input to the generative AI using the input information, the real world information, and the related information (step S105). For instance, the server 1 excludes a marathon course on which the user has already run, and in a case where the course is a neighboring marathon course and a load can be estimated from the heart rate or pulse of the user, this generates instruction information for obtaining a marathon course at an appropriate load level for the user.

Next, the server 1 generates the answer information by inputting the instruction information to the generative AI (step S106). At that time, the generative AI extracts the past instruction sentence by the user stored in a cache, and generates the answer information in consideration of the past instruction sentence. The server 1 presents the answer to the user by transmitting the answer information generated by the generative AI to the user terminal 2. Then, the answer generation processing ends.

The real world information is not limited to the example illustrated in FIG. 4, and may include a sound that can be acquired by a microphone, a scent that can be acquired by a smell sensor, a taste that can be acquired by a taste sensor, and the like.

According to such the information processing system 100, in the generative AI, it is possible to generate an answer in consideration of not only the latest instruction sentence but also the background and history (hereinafter, also referred to as “context”) leading to the instruction and question. Therefore, the user can acquire an appropriate answer in consideration of a situation of the user in the real world.

### Modifications

In the example embodiment described above, the user uses the user terminal 2, but the present disclosure is not limited to this, and the user may use a user terminal having a function of the server 1. In this case, the user terminal executes the answer generation processing performed by the server 1, and acquires an appropriate answer in consideration of the situation of the user in the real world using the generative AI.

### Second Example Embodiment

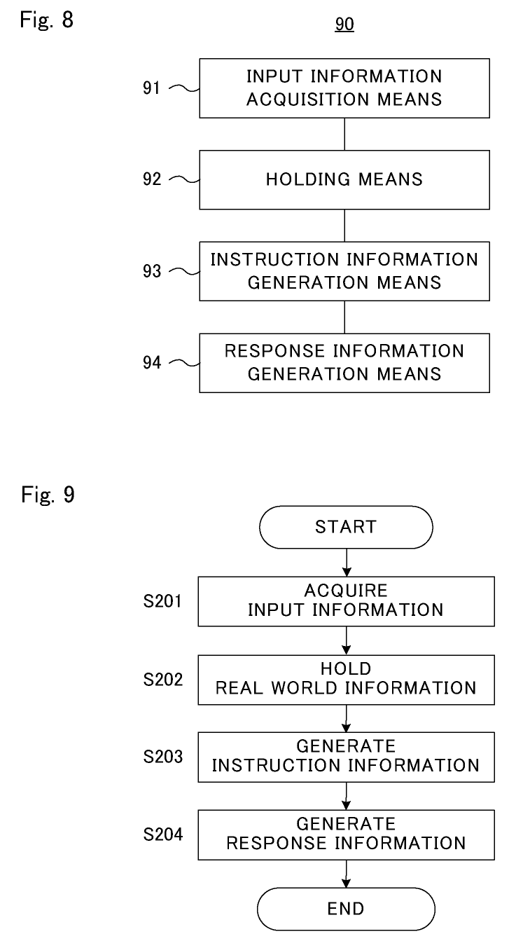

FIG. 8 is a block diagram illustrating an example of a functional configuration of an information processing device of the present disclosure. An information processing device 90 includes an input information acquisition means 91, a holding means 92, an instruction information generation means 93, and a response information generation means 94.

FIG. 9 is a flowchart illustrating an example of processing performed by the information processing device 90. The input information acquisition means 91 acquires input information input from a user (step S201). The holding means 92 holds real world information related to the user in a past fixed period starting from an input time point of the input information (step S202). The instruction information generation means 93 generates instruction information based on the input information and the real world information (step S203). The response information generation means 94 generates answer information based on the instruction information (step S204). According to the information processing device 90, it is possible to acquire an appropriate answer in consideration of a situation of the user in the real world. A part or all of the example embodiments described above may also be described as the following supplementary notes, but not limited thereto.

### Supplementary Note 1

An information processing device comprising:

an input information acquisition means configured to acquire input information input from a user;

a holding means configured to hold real world information related to the user in a past fixed period starting from an input time point of the input information;

an instruction information generation means configured to generate instruction information based on the input information and the real world information; and

an answer information generation means configured to generate answer information based on the instruction information.

### Supplementary Note 2

The information processing device according to supplementary note 1, wherein the instruction information generation means includes a selection means configured to select a data group for generating the instruction information based on the real world information, and

the selection means extracts characteristic information related to the user from the real world information, and excludes a data group not related to the characteristic information from a selection target.

### Supplementary Note 3

The information processing device according to supplementary note 2, wherein

the characteristic information is at least one or more of action purpose information related to the user, time information related to the input time point, spatial information related to a location of the user, and attribute information related to an attribute of the user.

### Supplementary Note 4

The information processing device according to supplementary note 1, wherein

the instruction information generation means includes a related information acquisition means configured to acquire the real world information and related information related to the input information from a predetermined data group, and generates the instruction information using the input information, the real world information, and the related information.

### Supplementary Note 5

The information processing device according to supplementary note 1, wherein

the answer information generation means generates the answer information by inputting the instruction information to generative AI.

### Supplementary Note 6

The information processing device according to supplementary note 3, further comprising:

an estimation means configured to estimate the action purpose information by integrating the real world information and inputting the integrated real world information to generative AI.

### Supplementary Note 7

The information processing device according to supplementary note 3, further comprising:

an estimation means configured to estimate the action purpose information by integrating the real world information and inputting the integrated real world information to generative AI.

### Supplementary Note 8

An information processing method executed by an information processing device, the method comprising:

acquiring input information input from a user;

holding real world information related to the user in a past fixed period starting from an input time point of the input information;

generating instruction information based on the input information and the real world information; and

generating answer information based on the instruction information.

### Supplementary Note 9

A program executed by an information processing device comprising a computer, the program that causes the computer to execute processing of:

acquiring input information input from a user;

holding real world information related to the user in a past fixed period starting from an input time point of the input information;

generating instruction information based on the input information and the real world information; and

generating answer information based on the instruction information.

### Supplementary Note 10

The program according to supplementary note 9 that causes the computer to execute processing of:

selecting a data group for generating the instruction information based on the real world information; and

extracting characteristic information related to the user from the real world information, and excluding a data group not related to the characteristic information from a selection target.

Some or all of the configurations described in Supplementary Notes 2 to 7, which are dependent on the above-described Supplementary Note 1, can also be dependent on Supplementary Note 8 through a dependency relationship similar to that of Supplementary Notes 2 to 8. Moreover, some or all of the configurations described in Supplementary Notes 2 to 7, which are dependent on the above-described Supplementary Note 1, can also be dependent on Supplementary Note 9 through a dependency relationship similar to that of Supplementary Notes 2 to 8. Furthermore, not limited to Supplementary Notes 1, 8, and 9, and within a range that does not depart from the above-described example embodiments, some or all of the configurations described in the Supplementary Notes can likewise be made dependent on various recording means, as well as on various pieces of hardware, software, or systems used for recording software.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Server

2 User terminal

11, 21 Interface

12, 22 Processor

13, 23 Memory

14, 24 Recording medium

15, 25 Display unit

16, 26 Input unit

31 Real world information DB

41 Input information acquisition unit

42 Real world information acquisition unit

43 Selection unit

44 Related information acquisition unit

45 Instruction information generation unit

46 Answer information generation unit

100 Information processing system

1. An information processing device comprising:
at least one memory configured to store instructions; and
at least one processor configured to execute the instructions to:
acquire input information input from a user;
hold real world information related to the user in a past fixed period starting from an input time point of the input information;
generate instruction information based on the input information and the real world information; and
generate answer information based on the instruction information.

2. The information processing device according to claim 1, wherein
in generating the instruction information, the processor selects a data group for generating the instruction information based on the real world information, and
the processor extracts characteristic information related to the user from the real world information, and excludes a data group not related to the characteristic information from a selection target.

3. The information processing device according to claim 2, wherein
the characteristic information is at least one or more of action purpose information related to the user, time information related to the input time point, spatial information related to a location of the user, and attribute information related to an attribute of the user.

4. The information processing device according to claim 1, wherein
in generating the instruction information, the processor acquires the real world information and related information related to the input information from a predetermined data group, and generates the instruction information using the input information, the real world information, and the related information.

5. The information processing device according to claim 1, wherein
in generating the answer information, the processor generates the answer information by inputting the instruction information to generative AI.

6. The information processing device according to claim 5, wherein
in generating the answer information, the processor generates the answer information by inputting the instruction information and past instruction information by the user to the generative AI.

7. The information processing device according to claim 3, wherein the processor is further configured to estimate the action purpose information by integrating the real world information and inputting the integrated real world information to generative AI.

8. An information processing method executed by an information processing device, the method comprising:
acquiring input information input from a user;
holding real world information related to the user in a past fixed period starting from an input time point of the input information;
generating instruction information based on the input information and the real world information; and
generating answer information based on the instruction information.

9. A non-transitory computer-readable recording medium storing a program causing a computer to execute processing of:
acquiring input information input from a user;
holding real world information related to the user in a past fixed period starting from an input time point of the input information;
generating instruction information based on the input information and the real world information; and
generating answer information based on the instruction information.

10. The non-transitory computer-readable recording medium according to claim 9, the program further causing the computer to execute processing of:
selecting a data group for generating the instruction information based on the real world information; and
extracting characteristic information related to the user from the real world information, and excluding a data group not related to the characteristic information from a selection target.
